(19) United States
(12) Patent Application Publication
(10) Pub. No.: US 2012/0224519 A1
(43) Pub. Date: Sep. 6, 2012

(54) COMMUNICATION METHOD OF A TARGET TERMINAL AND AN ACCESS POINT FOR GROUP ID MANAGEMENT IN MU-MIMO TRANSMISSION

(76) Inventors: Ui Kun Kwon, Hwaseong-si (KR); Young Soo Kim, Seoul (KR)

(21) Appl. No.: 13/225,684

(22) Filed: Sep. 6, 2011

(30) Foreign Application Priority Data
Mar. 2, 2011 (KR) 10-2011-0018662

(51) Int. Cl. H04W 72/04; H04W 52/02

(52) U.S. Cl. 370/311; 370/329

(57) ABSTRACT

Provided is a communication method of a target terminal and an access point (AP) for a group identification (ID) management in a multi-user multiple-input multiple-output (MU-MIMO) transmission capable of managing a group ID of members of a group without influencing other terminals in the group by transmitting membership information and position information to each of a plurality of terminals.

### CROSS-REFERENCE TO RELATED APPLICATION(S)

This application claims the benefit under 35 U.S.C. §119(a) of Korean Patent Application No. 10-2011-0018662, filed on Mar. 2, 2011, in the Korean Intellectual Property Office, the entire disclosure of which is incorporated herein by reference for all purposes.

### BACKGROUND

1. Field

The following description relates to a communication method of a target terminal and an access point (AP) for a group identification (ID) management in a multi-user multiple-input multiple-output (MU-MIMO) transmission.

2. Description of Related Art

Due to an increase in a number of users that access a mobile communication network and associated applications, a distribution of users and a traffic characteristic between users has diversified. Also, a quality of service (QoS) may be requested and provided between an associated application and a user. Thus, a multi-user multiple-input multiple-output (MU-MIMO) technology may be used to flexibly provide an enhanced throughput to multiple users.

The MU-MIMO technology using a wide channel band width and a multi-antenna technology may share a wireless resource by enabling a single transmission end to simultaneously transmit different signals to multiple reception ends. For example, the single transmission end may be an access point (AP) and the multiple reception ends may be a plurality of terminals.

In the MU-MIMO technology in a wireless local area network (LAN) environment, a transmitter such as the access point may only need to transmit data to a portion of the terminals included in the network. Accordingly, there is a desire for a communication method that is capable of effectively reporting a group identification (ID) that identifies one or more target terminals to each terminal in the network and a method of managing the group ID.

### SUMMARY

In one general aspect, there is provided a communication method of an access point (AP) in a wireless network including the AP and a plurality of terminals, the method including acquiring a transmission opportunity (TXOP) with respect to a channel, forming at least one group based on the plurality of terminals, transmitting, to each of the plurality of terminals, membership information indicating whether each of the plurality of terminals is included in the at least one group and position information indicating a position of each of the plurality of terminals that are included in the at least one group, and simultaneously transmitting data streams to the at least one group during the acquired TXOP.

The position information may indicate an ordered position of each of the plurality of terminals that are included in the at least one group.

The transmitting of the membership information and the position information may comprise generating the membership information in a bitmap with respect to a group identification (ID) of the at least one group.

The position information may include predetermined information or exclude information with respect to a terminal that is not a member of the at least one group.

The method may further comprise transmitting information that is associated with an update of the at least one group.

The transmitting of the information that is associated with an update may comprise transmitting update information indicating whether an update is performed in the at least one group, updated membership information indicating whether each of the plurality of terminals are included in the at least one updated group, and updated position information indicating a position of each of the plurality of terminals that are included in the at least one updated group.

The method may further comprise generating a group management function indicator based on whether the membership information and the position information are to be transmitted or whether the update information, the updated membership information, and the updated position information are to be transmitted.

The transmitting of the update information may comprise generating the update information in a bitmap with respect to a group ID of the at least one group.

In another aspect, there is provided a communication method of a target terminal in a wireless network including an access point (AP) and a plurality of terminals, the method including receiving membership information indicating whether the target terminal is included in at least one group and position information indicating a position of the target terminal in the at least one group, in response to a formation of the at least one group based on the plurality of terminals, and extracting a desired data stream from among data streams simultaneously transmitted from the AP according to the membership information and the position information during an acquired TXOP by the AP with respect to a channel.

The method may further comprise changing an operation state of the terminal to one of an awake state and a sleep state based on the membership information or the position information.

The method may further comprise receiving update information indicating whether an update is performed in the at least one group, updated membership information indicating whether the target terminal is included in the at least one updated group, and updated position information indicating a position of the target terminal that is included in the at least one updated group.

The extracting may comprise extracting a desired data stream from among data streams simultaneously transmitted from the AP based on the update information, the updated membership information, and the updated position information.

The method may further comprise receiving a group management function indicator indicating whether the AP transmits the membership information and the position information or whether the AP transmits the update information, the updated membership information, and the updated position information.

In another aspect, there is provided a computer-readable storage medium comprising program instructions to cause a processor to implement a method of an access point (AP) in a wireless network including the AP and a plurality of terminals, the method including acquiring a transmission opportunity (TXOP) with respect to a channel, forming at least one group based on the plurality of terminals, transmitting, to each of the plurality of terminals, membership information indicating whether each of the plurality of terminals is included in the at least one group and position information indicating a position of each of the plurality of terminals that are included in the at least one group, and simultaneously transmitting data streams to the at least one group during the acquired TXOP.

In another aspect, there is provided a terminal included in a wireless network comprising an access point (AP), the terminal including a receiver configured to receive, from the AP, a frame comprising management information indicating that the terminal is included in a group of terminals that are to receive data and a position of the terminal in the group, and a controller configured to control the terminal in power saving mode, wherein the receiver is further configured to receive update information from the AP indicating a change in the state of the group of terminals that are to receive data.

The update information may comprise a group ID, a one-bit update information bit for each group ID indicating whether the group is an updated group, updated membership information, and updated position information for each group ID.

The frame received from the AP may comprise a one-bit indicator that indicates whether the frame membership information and position information, or whether the frame comprises update information, updated membership information, and updated position information.

In response to the terminal not being included in an updated group ID included in a preamble of the frame, the controller may control the terminal to operate in sleep mode for the remainder of a transmission opportunity (TXOP) obtained by the AP.

In response to the terminal being included in an updated group ID included in a preamble of the frame but a more data bit (MDB) included in a MAC header indicating that there is no more data for the terminal to receive during a TXOP obtained by the AP, the controller may control the terminal to operate in sleep mode for the remainder of the TXOP obtained by the AP.

Other features and aspects may be apparent from the following detailed description, the drawings, and the claims.

### BRIEF DESCRIPTION OF THE DRAWINGS

FIG. 1 is a diagram illustrating an example of a multi-user multiple-input multiple-output (MU-MIMO) communication system that includes an access point (AP) that transmits data to multiple terminals.

FIG. 2 is a diagram illustrating an example of assigning a group identification (ID).

FIG. 3 is a flowchart illustrating an example of a communication method of an AP.

FIG. 4 is a flowchart illustrating an example of a communication method of a terminal.

FIG. 5 is a diagram illustrating an example of transmitting membership information and position information to each of a plurality of terminals included in a group.

FIG. 6 is a diagram illustrating an example of transmitting information associated with an updated group.

FIG. 7 is a diagram illustrating an example of a group management function indicator for selectively transmitting information about a group or an updated group.

FIG. 8 is a diagram illustrating an example of an operation of at least one terminal in a transmission opportunity (TXOP) power saving mode.

FIG. 9 is a diagram illustrating an example of a terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

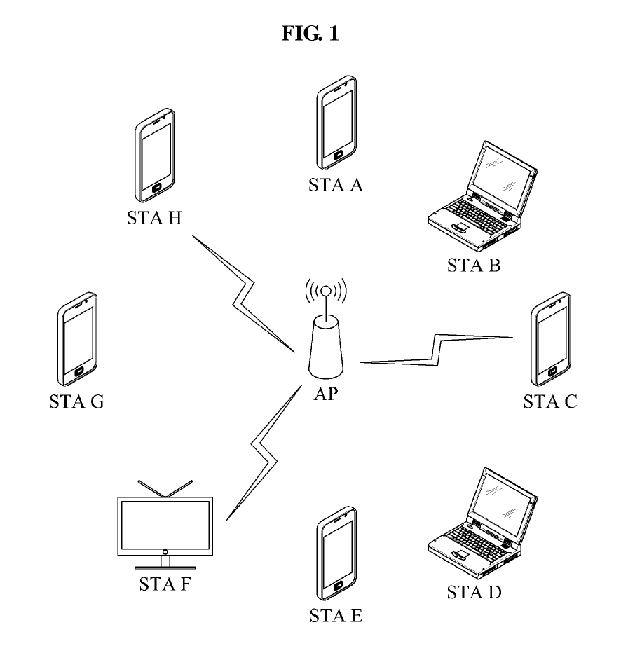

FIG. 1 illustrates an example of a multi-user multiple-input multiple-output (MU-MIMO) communication system that includes an access point (AP) that transmits data to multiple terminals.

Referring to FIG. 1, a single transmission end may have at least one antenna. The AP may transmit a signal to at least one reception end that has at least one antenna, for example, at least one terminal from among stations A through H. Thus, the MU-MIMO communication may be referred to as a multi-user multi-antenna technology. Hereinafter, an MU-MIMO may refer to a multi-user multi-antenna and an MU-MIMO transmission scheme may refer to a multi-user multi-antenna transmission scheme.

In a network for MU-MIMO communication, the AP may configure terminals such that data streams are simultaneously transmitted in a single group or in a plurality of groups. The AP may configure the single group or the plurality of groups with respect to terminals based on a predetermined criterion, such as, for example, a quality of service (QoS) requirement, a channel state, and the like. The AP may inform the terminals of information about the member of each group.

For example, “simultaneously transmitting data streams” may indicate that data streams are simultaneously transmitted spatially or that the MIMO is used by multiple users, and may not necessarily indicate that a transmission of a stream corresponding to a plurality of terminals simultaneously starts and ends.

The AP may inform terminals of information about a member of a group using a management frame that includes a group identification (ID). In this example, the group ID may be configured with respect to a cell in which the terminals belong or a set of each terminal in a basic service set (BSS).

In order to perform MU-MIMO communication in a wireless LAN environment of FIG. 1, the AP may indicate a target terminal that is to receive a corresponding frame for each transmission frame using the group ID.

For example, if an AP is to simultaneously transmit frames or data streams to three terminals STA C, STA F, and STA H, the AP may report that a corresponding frame is transmitted to each terminal STA C, STA F, and STA H using the group ID.

Hereinafter, an example of a scheme of assigning a group ID to a plurality of terminals is described.

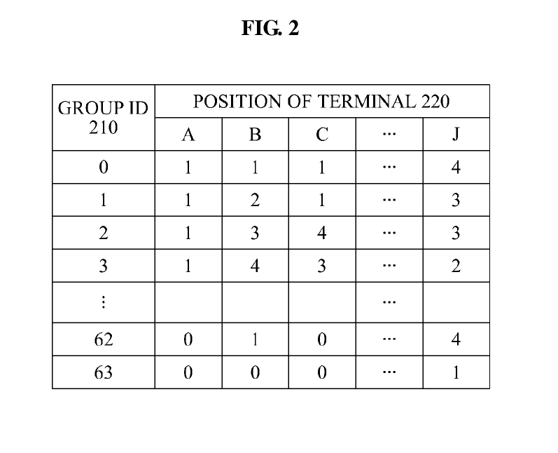

FIG. 2 illustrates an example of assigning a group ID.

Prior to the scheme of assigning a group ID according to various examples, a general scheme of assigning a group ID to a plurality of terminals is described with reference to Table 1.

TABLE 1

Position of terminal

| Group ID | 1 | 2 | 3 | 4 |
|---|---|---|---|---|
| 0 | A, B, C, D | E, F, G | H | I, J |
| 1 | A, C, E | B, D | F, J, I | G, H |
| 2 | A, E | H, I | B, G, I | C, D, F |
| 3 | A, G | C, H, J | C, E | B, D, F, I |
| . . . | . . . | . . . | . . . | . . . |
| 62 | B | E | G | I |
| 63 | D | F | H | J |

Table 1 illustrates an example in which 6 bits are used to indicate a group ID, that is, in which 2⁶=64 group IDs are used.

If a relatively large number of terminals are included in a cell or a BSS, 64 group IDs may define merely a portion of groups of terminals that are capable of transmitting frames simultaneously.

If bits for indicating a group ID are insufficient, an overloaded group ID assignment may be used to enable each group ID to simultaneously define a set of several terminals such as group IDs 1 through 4 of Table 1. As an example, a single frame may be simultaneously transmitted to a maximum of four terminals.

A target terminal that receives a frame for a first position in a group ID “0” corresponds to one of terminals A, B, C, and D that are present in a position “1” in the group ID “0” as shown in Table 1. A target terminal that receives a frame for a second position corresponds to one of terminals E, F, and G that are present in a position “2” in the group ID “0.” A target terminal that receives a frame for a third position corresponds to terminal H that is present in a position “3” in the group ID “0”. A target terminal that receives a frame for a fourth position corresponds to one of a terminal I and a terminal J that are present in a position “4” in the group ID “0”.

The group ID “0” may define 4×3×1×2=24 groups using a single group ID through the aforementioned scheme. Accordingly, a frame may be transmitted to a single group from among 24 groups defined by the group ID “0.”

In this example, an ambiguity with respect to a target terminal substantially receiving a frame may be relieved using a cyclic redundancy check (CRC) of control information, address information of a medium access control (MAC) header, and the like, which are transmitted after information about the group ID is transmitted.

However, if the group ID is managed using a scheme such as that described in the example of Table 1, and a target terminal included in a group changes, all target terminals included in the group in which a change occurs may be influenced. For example, the change of a target terminal included in the group may correspond to a change of a channel state, an inclusion of a new terminal in the BSS, a withdrawal of an existing target terminal from the group, and the like.

In the above MU-MIMO communication, even a terminal included as a member in a group may not be informed of information about other terminals included in the group.

Thus, a scheme may be used to respectively inform each of a plurality of terminals of membership information indicating whether each of the plurality of terminals that are included in at least one group and position information indicating a position of each respective terminal that is included in the at least one group.

Referring to FIG. 2, the membership information and the position information may be transmitted to each of the plurality of terminals, respectively, using six bits for indicating a group ID 210 and three bits for indicating a position of a terminal 220.

For example, when a group in which the group ID 210 corresponds to “1” is viewed, terminals A, B, C, . . . , and J are included in the group where the group ID 210 corresponds to “1,” terminals A and C are in a first position, a terminal B is in a second position, and a terminal J is in a third position in the corresponding group.

However, in contrast to Table 1, the membership information and the position information may be transmitted to each of the plurality of terminals included in the group in FIG. 2. Thus, a group member and a group ID may be more effectively managed in comparison with a scheme of Table 1.

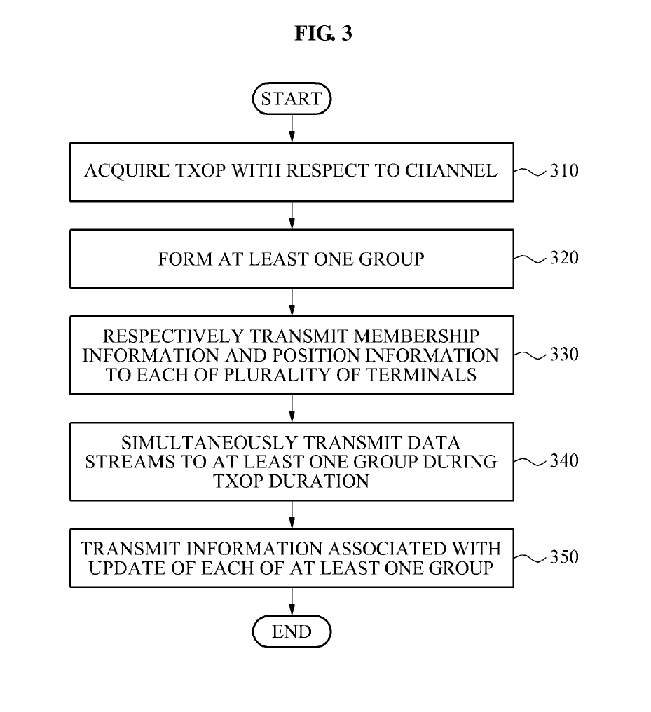

FIG. 3 illustrates an example a communication method of an AP. The communication method of the AP in a wireless network including the AP and a plurality of terminals are described herein.

In 310, the AP acquires a transmission opportunity (TXOP) with respect to a channel. In 320, the AP forms at least one group based on the plurality of terminals. In 330, the AP transmits membership information and position information to each of the plurality of terminals.

Operations illustrated in FIG. 3 may not be performed successively. As an example, operation 310 of acquiring the TXOP with respect to a channel may be performed after operations 320, 330, and the like. Another example may include performing operations illustrated in FIG. 3 in a predetermined order.

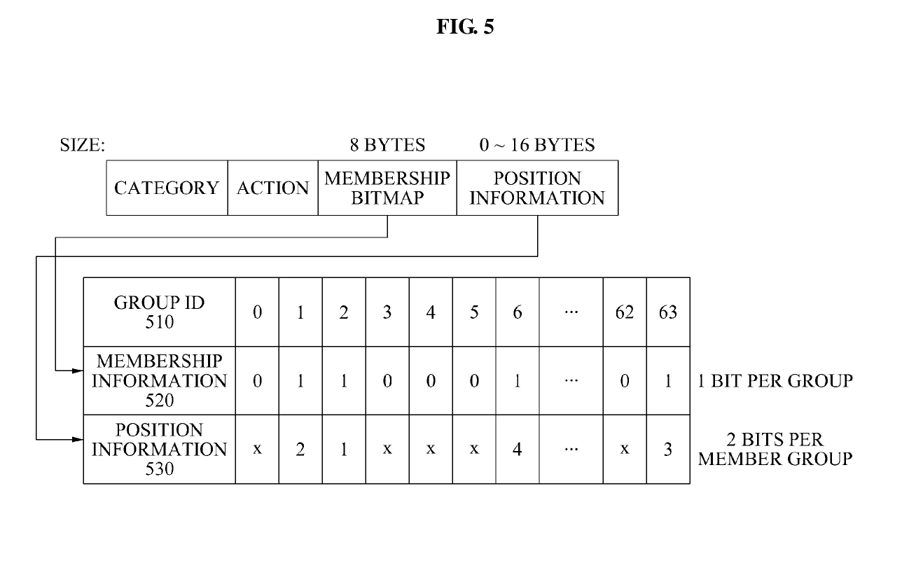

The membership information may be used to indicate which of the plurality of terminals that are included in the at least one group, and the position information may correspond to information indicating a position of the terminals that are included in the at least one group. The position information may indicate an ordered position of each terminal in the at least one group. The position information may include predetermined information, for example, an X or may exclude information with respect to a terminal not corresponding to a member of the at least one group. For example, the AP may indicate the membership information with respect to a group ID using a bitmap. An example of transmitting, by the AP, the membership information and the position information respectively to each of the plurality of terminals is described with reference to FIG. 5.

In 340, the AP simultaneously transmits data streams to the at least one group during a TXOP duration corresponding to the acquired TXOP.

The TXOP duration is a time interval during which the AP acquiring the TXOP with respect to a channel transmits at least one frame including data streams to the at least one group including the plurality of terminals.

In 350, the AP transmits update information associated with an update of the at least one group to each of the plurality of terminals. The update information may include, for example, update information, updated membership information, updated position information, and the like.

The update information may indicate whether an update is performed in the at least one group. The updated membership information may indicate whether the plurality of terminals belong to at least one updated group. The updated position information may indicate a position of each terminal included in the at least one updated group. The information indicating substantially updated content with respect to an updated group such as the updated membership information and updated position information, may be referred to as “information about an updated group.”

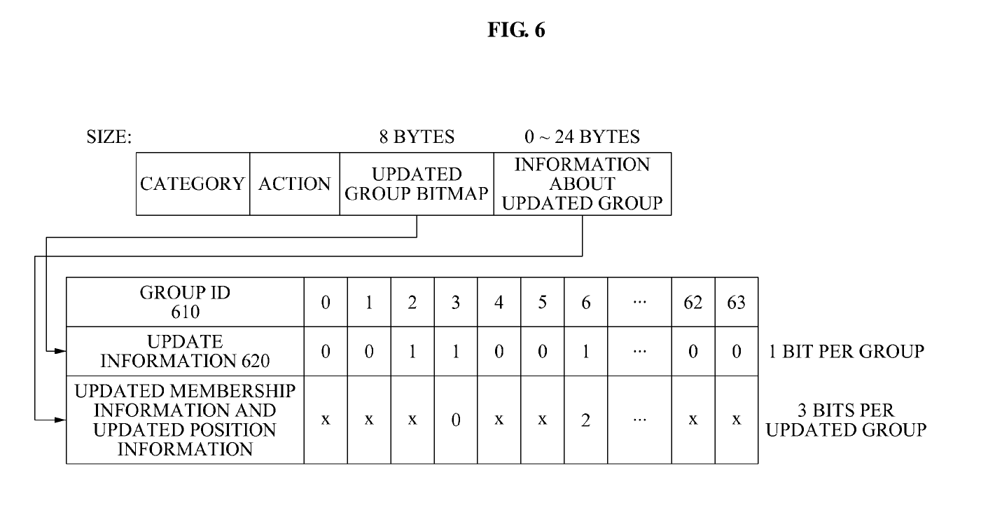

An example of transmitting the update information associated with an update of the at least one group, by the AP, is described with reference to FIG. 6.

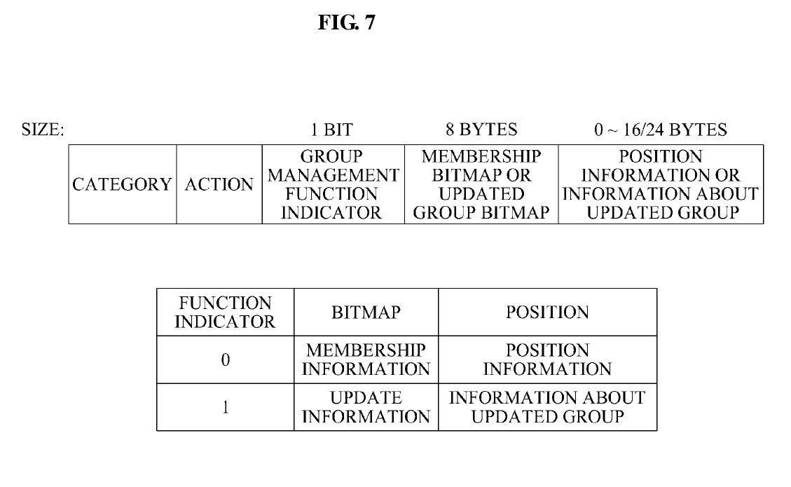

The AP may transmit the update information to each of the plurality of terminals using a bitmap. The AP may generate a group management function indicator based on whether the membership information and the position information are to be transmitted or whether the update information, the updated membership information, and the updated position information are to be transmitted. An example of selectively transmitting the membership information and the position information, or the information associated with an update of the at least one group, using the group management function indicator is described with reference to FIG. 7.

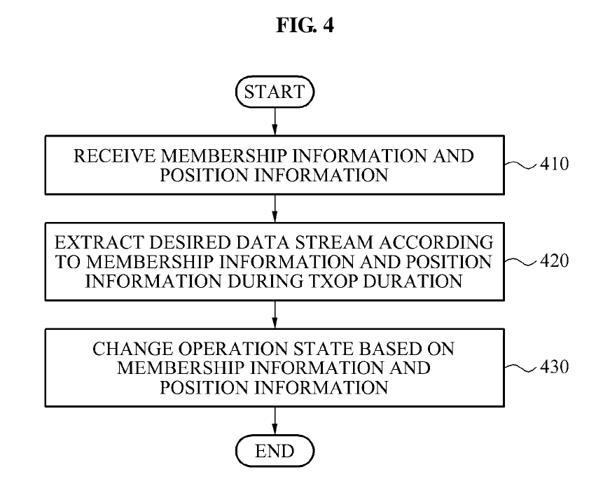

FIG. 4 illustrates an example of a communication method of a terminal.

In 410, the target terminal receives membership information and position information from the AP, in response to a formation of the at least one group based on the plurality of terminals. For example, the membership information may indicate whether the target terminal belongs to at least one group, and the position information may correspond to information indicating a position of the target terminal in the at least one group.

During a TXOP acquired by the AP, the AP may simultaneously transmit data streams to one or more terminals included in the group. In 420, the target terminal extracts a desired data stream from among data streams that are simultaneously transmitted from the AP according to the membership information and the position information.

For example, the target terminal may extract a desired data stream from among data streams simultaneously transmitted from the AP based on the update information, the updated membership information, and the updated position information, in response to an occurrence of an update in the at least one group.

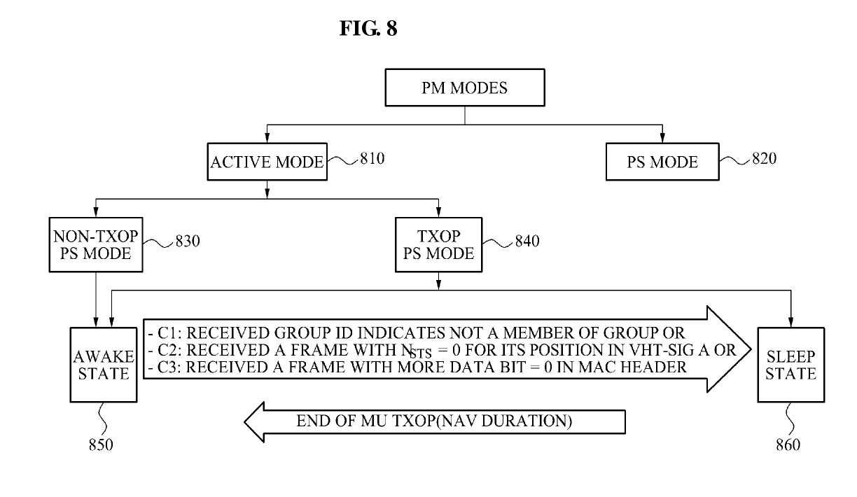

The target terminal may determine a power management mode of the target terminal before entering the TXOP duration. An example of a power management mode is described with reference to FIG. 8.

In 430, the target terminal changes an operation state of the terminal according to the power management mode. For example, the operation state may be changed to one of an awake state and a sleep state, based on the membership information and/or the position information.

The target terminal may receive update information, updated membership information, and updated position information from the AP. The update information may indicate whether an update is performed in the at least one group. The updated membership information may indicate whether the target terminal is included in the at least one updated group. The updated position information may indicate a position of the target terminal in the at least one updated group.

The target terminal may receive a group management function indicator that indicates whether the AP transmits the membership information and the position information or whether the AP transmits the update information, the updated membership information, and the updated position information. An example of the group management function indicator is described with reference to FIG. 7.

FIG. 5 illustrates an example of transmitting membership information and position information to each of a plurality of terminals included in a group.

To indicate a target terminal through a group ID, terminals in a cell or BSS may share the group ID and information that is associated with the group ID before transmitting a data frame. For example, a management scheme may enable the terminals in the BSS to share the information that is associated with the group ID.

An AP may transmit the membership information and the position information to each of a plurality of terminals. In this example, the AP may transmit corresponding information, that is, the membership information and the position information of each of the plurality of terminals to each of the plurality of terminals based on a unicast scheme and/or a broadcast scheme.

The membership information may indicate whether each of the plurality of terminals is included in at least one group. The position information may indicate a position of each of the plurality of terminals in the at least one group. For example, the position information may indicate an ordered position of each of the plurality of terminals in the at least one group or indicate an order of each of the plurality of terminals with respect to the at least one group.

Referring to FIG. 5, the AP may transmit the membership information and the position information using a bitmap so as not to influence other terminals in the group. For example, the AP may transmit, to each of the plurality of terminals, the membership information and the position information using a full group ID table of FIG. 5.

If a number of group IDs 510 corresponds to 64 as illustrated in FIG. 5, membership information 520 may be indicated using 2⁶=64 membership bitmaps. In this example, the membership information 520 may indicate whether a terminal corresponds to a member of a group.

The AP may transmit position information 530 to each of the plurality of terminals after transmitting a bitmap indicating the membership information.

For example, it may be assumed that the full group ID table of FIG. 5 indicates the membership information and the position information with respect to a terminal A.

The membership information 520 may be used to indicate whether terminal A is included in group IDs 0, 1, 2, 3, . . . , 63. In this example, the position information 530 indicates that terminal A is present at a second position in a group having 1 as the group ID, terminal A is present at a first position in a group having 2 as the group ID, terminal A is present at a fourth position in a group having 6 as the group ID, and terminal A is present at a third position in a group having 63 as the group ID. The membership information 520 also indicates that terminal A is not present in the groups that have group IDs 0, 3, 4, 5, 62, and the like.

The position information 530 may have 0 to 64×2 bits of variable length when a number of the group IDs corresponds to 64. For example, if terminal A is included as a member in 10 groups each having a group ID from among 64 groups, terminal A may transmit position information of 2 bits for each of the 10 group IDs, that is, position information of 20 bits.

If position information having a fixed length is used, the AP may transmit position information with respect to all group IDs to the target terminal. The AP may assign predetermined position information to a group which does not include the target terminal as a member.

FIG. 6 illustrates an example of transmitting information associated with an updated group.

A state of terminals that are included in at least one group may undergo changes to the channel state, such as an inclusion of a new terminal in a cell or BSS, a withdrawal of an existing terminal from the group, and the like. If the state of the terminals included in at least one group changes, information of a group ID with respect to terminals having a changed state may be changed or updated.

Referring to FIG. 6, an AP may update or change a portion of information with respect to a corresponding group in response to a state of terminals included in the at least one group changing. For example, the AP may use a partial group ID table as illustrated in FIG. 6 to update a portion of a content with respect to the corresponding group. The AP may transmit an updated group bitmap and information about an updated group in order to transmit information that is associated with an update of the at least one group to each of the respective target terminals included in the group.

For example, the updated group bitmap may include eight bits, and may indicate update information 620, indicating whether an update is performed in the at least one group, in a bitmap form of one bit per group. The information about an updated group may include 0 to 24 bytes, and may include updated membership information and updated position information 630. The update information 620, the updated membership information, and the updated position information 630 may be used with respect to a group ID 610 of the at least one group. The update information 620 may report, through a bitmap, a group ID that has a change in content from among all group IDs.

In the example of FIG. 6, “1” is set as the update information 620 with respect to groups having 2, 3, and 6 as the group ID 610. In this example, the “1” is used to indicate that content of groups having 2, 3, and 6 as the group ID 610 has changed. A group in which “0” is set as the update information 620 may indicate content of the group is unchanged.

The updated membership information may indicate whether each of the plurality of terminals are included in the at least one updated group, and the updated position information 630 may indicate a position of each of the plurality of terminals that are included in the at least one updated group.

The updated membership information and the updated position information 630 may indicate a change in content with respect to a group having a changed content.

For example, if four positions are present for each group ID, three bits may be used for each group ID to indicate information about an updated group. Thus, the updated membership information and the updated position information 630 may use three bits to indicate the information about the updated group.

In this example, one bit from among the three bits may be used to indicate the updated membership information, that is, one bit may be used to indicate whether each of the plurality of terminals belongs to the at least one group. The remaining two bits may be used to indicate the updated position information, that is, a position of each of terminals in the at least one updated group when a corresponding terminal is included in the group.

Thus, if a number of group IDs corresponds to 64, the information about the updated group may have 3 to 3×64 bits in length.

An example of a group having 2 as the group ID 510 in FIG. 5 and the group ID 610 in FIG. 6 is reviewed below.

Referring to FIG. 5, the group that has 2 as the group ID 510 has 1 as the membership information 520. Accordingly, terminal A is included in a group having 2 as the group ID 510. Because the position information 530 corresponds to 1, terminal A is recognized as being at a first position in the group having 2 as the group ID 510.

Referring to FIG. 6, the update information 620 having 2 as the group ID 610 is set to 1. In this example, content of a group having 2 as the group ID 610 is recognized as being changed.

As described herein, one bit from among the three bits indicating the updated membership information and the updated position information 630 may be used to indicate the updated membership information, that is, may be used to indicate whether each of the plurality of terminals belongs to the at least one group. The remaining two bits may be used to indicate the updated position information, that is, a position of each terminals in the at least one updated group when a corresponding terminal is included in the group.

However, the updated membership information and the updated position information 630 of the group having 2 as the group ID 610 is X. The X may be used to indicate that terminal A is no longer included in a group having 2 as an updated group ID, and may not have a position in the group having 2 as an updated group ID.

FIG. 7 illustrates an example of a group management function indicator for selectively transmitting information about a group or an updated group.

An AP may use the group management function indicator of one bit to selectively transmit the membership information and position information, or the update information and information about an updated group as described herein with reference to the examples of FIG. 5 and FIG. 6.

For example, if the membership information and the position information are to be transmitted to each of plurality of terminals, the AP may set the group management function indicator to “0.”

If the update information, the updated membership information, and the updated position information are to be transmitted to each of the plurality of terminals, the AP may set the group management function indicator to “1.”

In this example, a target terminal may use the group management function indicator to recognize whether the AP transmits the membership information and the position information, or whether the AP transmits the update information, the updated membership information, and the updated position information.

FIG. 8 illustrates an example of an operation of at least one terminal in a TXOP power saving mode.

The at least one terminal receiving data from an AP may remain in an active mode to receive a packet or a frame that is to be transmitted to the at least one terminal. Even though no packets are transmitted to the at least one terminal, the at least one terminal may remain in the active mode to monitor a packet that is transmitted to another terminal.

Thus, in response to an absence of transmission of data corresponding to a target terminal from among the at least one terminal or a termination of transmission of data, an operation mode of the target terminal may be adjusted in order to reduce a reception standby time or reception standby power. Accordingly, power may be consumed.

Referring to FIG. 8, a power management mode of the at least one terminal is classified into an active mode 810 and a power saving (PS) mode 820. The active mode 810 may be a state in which the at least one terminal continues to operate to exchange data with the AP. The PS mode 820 may be a state in which the at least one terminal does not perform any operation, for example, an idle state. The active mode 810 may be further classified into a non-TXOP PS mode 830 and a TXOP PS mode 840.

In this example, a terminal operating in the non-TXOP PS mode 830 may continue to remain in an awake state without a predetermined operation for reducing power consumption. Thus, the terminal may continue to consume power during the reception standby time while waiting for a reception of a packet transmitted to the terminal.

As another example, a terminal operating in the TXOP PS mode 840 may change the operation state to an awake state or a sleep state which may also be referred to as a doze state, based on whether a predetermined condition is satisfied.

The predetermined condition may include, for example, a condition in which the target terminal is excluded from a group ID included in a preamble of a frame received from the AP, a condition in which the target terminal is included in the group ID and a number of state time space (Nsts) included in a Very High Throughput SIGnal (VHT-SIG) field corresponds to “0,” a condition in which a more data bit (MDB) included in an MAC header of a received frame corresponds to “0,” and the like.

In this example, the condition in which an Nsts included in a VHT-SIG field corresponds to “0” may indicate an absence of data or stream corresponding to the target terminal for the TXOP duration.

The condition in which an MDB included in an MAC header of a received frame corresponds to “0” may indicate there is no more data to be transmitted to the target terminal, that is, a transmission of a stream corresponding to the target terminal that was previously transmitted during the TXOP is now terminated.

The target terminal satisfying any of the conditions may reduce the reception standby power during the remainder of the TXOP duration by changing the operation state from the awake state to the sleep state. The TXOP duration is a time interval corresponding to a TXOP with respect to a channel acquired by the AP.

The target terminal operating in the TXOP PS mode 840 may reduce the reception standby power and a power consumption of a reception device by changing the operation state during the TXOP duration according to predetermined conditions.

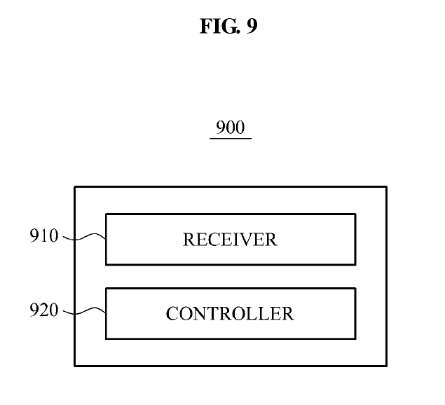

FIG. 9 illustrates an example of a terminal.

Referring to FIG. 9, terminal 900 includes a receiver 910 and a controller 920. The terminal may be included in a wireless network comprising at least one access point (AP).

The receiver 910 may receive, from an AP, a frame comprising management information indicating that the terminal 900 is or is not included in a group of terminals that are to receive data from the AP. The management information may also include a position of the terminal 900 in the group. The receiver 910 may further receive update information from the AP indicating a change in the state of the group of terminals that are to receive data.

For example, the update information may include a group ID, a one-bit update information bit for each group ID indicating whether the group is an updated group, updated membership information, and updated position information for each group ID.

The frame received from the AP may include a one-bit indicator that indicates whether the frame includes membership information and position information, or whether the frame includes update information, updated membership information, and updated position information.

The controller 920 may control the terminal 900 to operate in a power saving mode. For example, in response to an ID of the terminal 900 not being included in an updated group ID included in a preamble of the frame, the controller 920 may control the terminal 900 to operate in sleep mode for the remainder of a transmission opportunity (TXOP) obtained by the AP.

As another example, in response to an ID of the terminal 900 being included in an updated group ID included in a preamble of the frame but a more data bit (MDB) included in a MAC header indicating that there is no more data for the terminal 900 to receive during a TXOP obtained by the AP, the controller 920 may control the terminal 900 to operate in sleep mode for the remainder of the TXOP obtained by the AP.

The examples described with respect to FIGS. 1-8 are also applicable to the terminal 900 described with respect to FIG. 9

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running. As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of an access point (AP) in a wireless network including the AP and a plurality of terminals, the method comprising:
acquiring a transmission opportunity (TXOP) with respect to a channel;
forming at least one group based on the plurality of terminals;
transmitting, to each of the plurality of terminals, membership information indicating whether each of the plurality of terminals is included in the at least one group and position information indicating a position of each of the plurality of terminals that are included in the at least one group; and
simultaneously transmitting data streams to the at least one group during the acquired TXOP.

2. The method of claim 1, wherein the position information indicates an ordered position of each of the plurality of terminals that are included in the at least one group.

3. The method of claim 1, wherein the transmitting of the membership information and the position information comprises generating the membership information in a bitmap with respect to a group identification (ID) of the at least one group.

4. The method of claim 1, wherein the position information includes predetermined information or excludes information with respect to a terminal that is not a member of the at least one group.

5. The method of claim 1, further comprising:
transmitting information that is associated with an update of the at least one group.

6. The method of claim 5, wherein the transmitting of the information that is associated with an update comprises transmitting update information indicating whether an update is performed in the at least one group, updated membership information indicating whether each of the plurality of terminals are included in the at least one updated group, and updated position information indicating a position of each of the plurality of terminals that are included in the at least one updated group.

7. The method of claim 6, further comprising:
generating a group management function indicator based on whether the membership information and the position information are to be transmitted or whether the update information, the updated membership information, and the updated position information are to be transmitted.

8. The method of claim 6, wherein the transmitting of the update information comprises generating the update information in a bitmap with respect to a group ID of the at least one group.

9. A communication method of a target terminal in a wireless network including an access point (AP) and a plurality of terminals, the method comprising:
receiving membership information indicating whether the target terminal is included in at least one group and position information indicating a position of the target terminal in the at least one group, in response to a formation of the at least one group based on the plurality of terminals; and
extracting a desired data stream from among data streams simultaneously transmitted from the AP according to the membership information and the position information during an acquired TXOP by the AP with respect to a channel.

10. The method of claim 9, further comprising:
changing an operation state of the terminal to one of an awake state and a sleep state based on the membership information or the position information.

11. The method of claim 9, further comprising:
receiving update information indicating whether an update is performed in the at least one group, updated membership information indicating whether the target terminal is included in the at least one updated group, and updated position information indicating a position of the target terminal that is included in the at least one updated group.

12. The method of claim 11, wherein the extracting comprises extracting a desired data stream from among data streams simultaneously transmitted from the AP based on the update information, the updated membership information, and the updated position information.

13. The method of claim 9, further comprising:
receiving a group management function indicator indicating whether the AP transmits the membership information and the position information or whether the AP transmits the update information, the updated membership information, and the updated position information.

14. A computer-readable storage medium comprising program instructions to cause a processor to implement a method of an access point (AP) in a wireless network including the AP and a plurality of terminals, the method comprising:
acquiring a transmission opportunity (TXOP) with respect to a channel;
forming at least one group based on the plurality of terminals;
transmitting, to each of the plurality of terminals, membership information indicating whether each of the plurality of terminals is included in the at least one group and position information indicating a position of each of the plurality of terminals that are included in the at least one group; and
simultaneously transmitting data streams to the at least one group during the acquired TXOP.

15. A terminal included in a wireless network comprising an access point (AP), the terminal comprising:
a receiver configured to receive, from the AP, a frame comprising management information indicating that the terminal is included in a group of terminals that are to receive data and a position of the terminal in the group; and
a controller configured to control the terminal in power saving mode,
wherein the receiver is further configured to receive update information from the AP indicating a change in the state of the group of terminals that are to receive data.

16. The terminal of claim 15, wherein the update information comprises a group ID, a one-bit update information bit for each group ID indicating whether the group is an updated group, updated membership information, and updated position information for each group ID.

17. The terminal of claim 15, wherein the frame received from the AP comprises:
a one-bit indicator that indicates whether the frame comprises membership information and position information, or whether the frame comprises update information, updated membership information, and updated position information.

18. The terminal of claim 15, wherein, in response to an ID of the terminal not being included in an updated group ID included in a preamble of the frame, the controller controls the terminal to operate in sleep mode for the remainder of a transmission opportunity (TXOP) obtained by the AP.

19. The terminal of claim 15, wherein, in response to an ID of the terminal being included in an updated group ID included in a preamble of the frame but a more data bit (MDB) included in a MAC header indicating that there is no more data for the terminal to receive during a TXOP obtained by the AP, the controller controls the terminal to operate in sleep mode for the remainder of the TXOP obtained by the AP.
